(19) United States
(12) Patent Application Publication
(10) Pub. No.: US 2024/0293773 A1
(43) Pub. Date: Sep. 5, 2024

(54) ABSORBENT AQUEOUS COMPOSITION CONTAINING A BASE AND AN AZOLE FOR SEPARATING CARBON DIOXIDE FROM A GASEOUS EFFLUENT

(71) Applicant: IFP ENERGIES NOUVELLES, RUEIL-MALMAISON (FR)

(72) Inventors: Guillaume PETAUD, RUEIL-MALMAISON CEDEX (FR); Etienne GIREL, RUEIL-MALMAISON CEDEX (FR)

(73) Assignee: IFP ENERGIES NOUVELLES, RUEIL-MALMAISON (FR)

(21) Appl. No.: 18/575,093

(22) PCT Filed: Jun. 27, 2022
(86) PCT No.: PCT/EP2022/067622

§ 371 Date: Dec. 28, 2023

(30) Foreign Application Priority Data
Jul. 2, 2021 (FR) FR2107216

(51) Int. Cl. B01D 53/62; B01D 53/14; B01D 53/78; B01D 53/96

(52) U.S. Cl. CPC B01D 53/62; B01D 53/1493; B01D 53/78; B01D 53/96; B01D 2251/306; B01D 2251/80; B01D 2252/504; B01D 2257/504

(57) ABSTRACT

The present invention relates to an absorbent composition for absorbing the carbon dioxide contained in a gaseous effluent comprising the combination of a base B or of a mixture of bases B of carbonate, hydrogen carbonate or hydroxide type with at least one unsaturated heterocyclic organic compound R(NH)ₙ wherein the radical R is an alicyclic, monoaromatic or polyaromatic, or heterocyclic group having at least one nitrogen atom, and n is between 1 and 20, in an aqueous solvent Z and/or the product obtained by reaction of said base B or of said mixture of bases B with said compound R(NH)ₙ in said aqueous solvent Z. The invention also relates to a process to capturing the CO₂ in a gaseous effluent using said composition.

### TECHNICAL FIELD

The present invention relates to the decarbonation of a gaseous effluent, more particularly the invention relates to an absorbent aqueous composition for capture of the CO₂ contained in a gaseous effluent.

### PRIOR ART

Carbon dioxide is one of the greenhouse gases widely produced by various human activities and has a direct impact on atmospheric pollution.

In order to reduce the amounts of carbon dioxide emitted into the atmosphere, it is possible to capture the CO₂ contained in a gaseous effluent.

The decarbonation of gaseous effluents such as for example natural gas, synthesis gases, combustion flue gases, refinery gases, tail gases from the Claus process, biomass fermentation gases, cement plant gases and blast furnace gases is generally carried out by scrubbing with an absorbent solution. The physicochemical characteristics of the solutions used are closely related to the nature of the gas to be treated: selective removal of an impurity, expected specification for the treated gas, thermal and chemical stability of the solvent with respect to the various compounds present in the gas to be treated.

The solvents commonly used today include in particular aqueous solutions of primary, secondary or tertiary alkanolamines and optionally an organic cosolvent, such as methanol for example. Specifically, the CO₂ absorbed reacts with the alkanolamine present in solution according to a reversible exothermic reaction, well known to a person skilled in the art, leading to the formation of carbamates, hydrogen carbonates or carbonates. These balanced reactions can be written according to the schemes depicted in FIG. 1:

For a primary alkanolamine such as for example for monoethanolamine, the reaction brought into play is the reaction from FIG. 1 (at the top) which involves carbamate, hydrogen carbonate and carbonate ions.

For a secondary alkanolamine such as for example for diethanolamine, it is written according to FIG. 1 (in the center).

And for a tertiary alkanolamine such as for example for methyldiethanolamine, according to FIG. 1 (at the bottom).

One alternative to the aqueous alkanolamine solutions is the use of hot solutions of alkali metal carbonates. The principle is based on the absorption of the CO₂ in the aqueous solution, by an inorganic carbonate according to a reaction leading to an inorganic hydrogen carbonate and on the regeneration by the reversible reaction transforming an inorganic hydrogen carbonate to inorganic carbonate.

Certain processes of decarbonation by scrubbing with an absorbant solution such as polyethylene glycols or chilled methanol are based on a physical absorption of the CO₂.

French patent applications FR 2 909 010 and FR 2 909 011 describe the use of an absorbent composition for absorbing carbon dioxide that combines a particular base chosen respectively from amidines and guanidines or from phosphazenes with a compound comprising at least one thiol or alcohol function and optionally with a non-aqueous solvent.

French patent application FR 2 934 175 describes an absorbent composition for absorbing carbon dioxide, used in a process for capturing the carbon dioxide contained in a gaseous effluent, comprising, in an aqueous medium, the combination of a particular base chosen from carbonates and/or hydrogen carbonates with a compound chosen from thiols.

An essential aspect of the operations for solvent treatment of gases or flues gases remains the regeneration of the separating agent. Depending on the type of absorption (physical and/or chemical), regeneration by expansion, by distillation and/or by entrainment by a vaporized gas, known as “stripping gas”, is generally envisaged.

In general, the use of all the absorbent solutions described above requires a sizeable energy consumption for the regeneration of the separating agent. For example, the regeneration of an aqueous solution of ethanolamine used for capturing the CO₂ in a flue gas represents around 4 GJ per tonne of CO₂ captured. Such an energy consumption represents a considerable operating cost for the CO₂ capture process.

The applicant has discovered that the use of a particular absorbent composition, comprising, in an aqueous medium, the combination of a base chosen from carbonates and/or hydrogen carbonates and/or hydroxides with an azole compound, made it possible to obtain advantageous performance levels for capturing the CO₂ contained in a gaseous effluent.

### SUMMARY OF THE INVENTION

The invention relates to an absorbent composition for absorbing the carbon dioxide contained in a gaseous effluent comprising the combination of a base B or a mixture of bases B with at least one compound R(NH)ₙ in an aqueous solvent Z and/or the product obtained by reaction of said base B or of said mixture of bases B with said compound R(NH)ₙ in said aqueous solvent Z, wherein:
B is a base or a mixture of bases corresponding to one of the general formulae M(HCO₃)ₓ or M′_{y}(CO₃) or M″(OH)_{w}, where M, M′, M″, which are identical or different, are chosen without distinction from:
a monovalent cation such as lithium, sodium, potassium, rubidium or cesium,
a quaternary ammonium cation corresponding to the general formula R₁R₂R₃R₄N⁺ wherein R₁, R₂, R₃ and R₄ are independently chosen from a hydrogen atom, a branched or unbranched, saturated or unsaturated aliphatic, substituted or unsubstituted, saturated or unsaturated alicyclic, substituted or unsubstituted, saturated or unsaturated heterocyclic, substituted or unsubstituted monoaromatic or polyaromatic hydrocarbon-based group containing between 1 and 20 carbon atoms, it being possible for R₁, R₂, R₃ and R₄ to be bonded in pairs by covalent bonds to form a heterocycle with 5 to 8 atoms,
a divalent cation such as magnesium, calcium or barium,
and wherein x, y, w are equal to 1 or to 2;
R(NH)ₙ is an unsaturated heterocyclic organic compound or a mixture of unsaturated heterocyclic organic compounds, wherein the radical R is an alicyclic, monoaromatic or polyaromatic, or heterocyclic group having at least one nitrogen atom, and n is between 1 and 20, preferably between 1 and 6, very preferably n is equal to 2 or 3;
Z is essentially water or a mixture of solvents comprising water.

The base B or the mixture of bases B is chosen from the carbonates of lithium, sodium, potassium, cesium, rubidium, magnesium, calcium, barium, tetramethylammonium, tetraethylammonium, benzyltrimethylammonium and decyltrimethylammonium, the bicarbonates (or hydrogen carbonates) of lithium, sodium, potassium, cesium, rubidium, magnesium, calcium, barium, tetramethylammonium, tetraethylammonium, benzyltrimethylammonium and decyltrimethylammonium, the hydroxides of lithium, sodium, potassium, cesium and rubidium, magnesium, calcium and barium, alone or as a mixture.

Said compound R(NH)ₙ may be an unsaturated heterocyclic organic compound comprising at least 2, 3 or 4 nitrogen atoms in a ring of 5 or more atoms respectively comprising at least 3, 2 or 1 carbon atom(s), preferably said compound R(NH)ₙ is an organic compound with an unsaturated heterocycle containing five atoms, having at least one nitrogen atom per four carbon atoms.

Said radical R may contain one or more heteroatoms present by means of functions such as alcohols, ethers, thioethers, nitriles, ketones, sulfones, sulfoxides, amides or amines.

The compound R(NH)ₙ may be chosen from azoles such as imidazole,1,2,4-triazole, 2-methylimidazole, 1,2,3-triazole, 4(5)-methylimidazole, 3-amino-1,2,4-triazole, 2-isopropylimidazole, 2-ethyl-4-methylimidazole, 2-imidazolidone, 3,5-diamino-1,2,4-triazole, L-histidine, adenine, barbituric acid, methyl-1H-1,2,4-triazole-3-carboxylate, 2-ethylimidazole, 4-methyl-5-imidazolecarboxaldehyde, 2,4-dimethylimidazole, very preferably chosen from imidazole, 1,2,4-triazole, 2-methylimidazole, 1,2,3-triazole, 4(5)-methylimidazole and 3-amino-1,2,4-triazole.

Preferably, the compound R(NH)ₙ is chosen from imidazole, 2-methylimidazole, 4(5)-methylimidazole, 1,2,4-triazole, 3-amino-1,2,4 triazole.

In one embodiment, the solvent Z is essentially water.

In another embodiment, the solvent Z is water combined with another solvent or with a mixture of solvents that is/are miscible with water.

In this case, the water represents at least 30% by weight, preferably 50% by weight, very preferably 60% by weight relative to the total amount of solvent Z.

Said other solvent may be chosen from glycols, polyethylene glycols, polypropylene glycols, ethylene glycol-propylene glycol copolymers, glycol ethers, thioglycols, thioalcohols, sulfones, sulfoxides, alcohols, ureas, lactams, N-alkyl pyrrolidones, N-alkyl piperidones, cyclotetramethylene sulfones, N-alkylformamides, N-alkylacetamides, ether-ketones, alkyl phosphates, alkylene carbonates, dialkyl carbonates and derivatives thereof.

Said other solvent may notably be chosen from tetraethylene glycol dimethyl ether, sulfolane, dimethyl sulfoxide, ethanol, polyethylene glycols-200/400/600, N-methylpyrrolidone, 1,3-dioxan-2-one, dimethylformamide, dimethylacetamide, formamide, acetamide, 2-methoxy-2-methyl-3-butanone, 2-methoxy-2-methyl-4-pentanone, tetrahydropyrimidone, dimethyl thiodipropionate, bis(2-hydroxyethyl)sulfone or tributyl phosphate.

In the absorbent composition according to the invention, a moles of R(NH)ₙ may be combined with each mole of B, α being a positive number defined in order to satisfy the condition that at least one hydrogen atom bonded to N in the formula R(NH)ₙ must be combined with a basic function provided by B.

The invention also relates to a process for capturing carbon dioxide comprising a step of bringing the CO₂-containing gaseous effluent to be treated into contact with the absorbent composition according to any one of the variants described previously so as to deplete said gaseous effluent of CO₂ and to enrich said absorbent composition in CO₂ and a step of regenerating said absorbent composition and of generating a gas very rich in CO₂.

The regeneration of the absorbent composition enriched in CO₂ may be carried out by steam entrainment by means of a gas that entrains the carbon dioxide in the vapor phase or by heating or by expansion or by a combination of steps chosen from steam entrainment by means of a gas that entrains the carbon dioxide in the vapor phase, expansion and/or heating.

### LIST OF FIGURES

FIG. 1 represents the exothermic reaction according to which the CO₂ absorbed reacts with the alkanolamine present in an absorbent solution according to a reversible exothermic reaction leading to the formation of carbamates, hydrogen carbonates or carbonates, for a primary (1a), secondary (1b) and tertiary (1c) alkanolamine.

FIG. 2 represents the diagram of the CO₂ capture process with absorption and regeneration using an absorbent composition according to the invention.

FIG. 3 represents the amount of CO₂ captured per unit of amount of capturing agent available in the absorbent composition 1 according to the invention (imidazole and KOH) as a function of the equilibrium pressure of the system at the measurement temperatures (in order: x crosses 40° C., triple crosses 60° C., + symbols 70° C., dashes 80° C. and black squares 90° C.).

FIG. 4 represents the amount of CO₂ captured per unit of amount of capturing agent available in the absorbent composition 2 according to the invention (1,2,4 triazole and KOH) and illustrates the role of the temperature (in order as above: 40° C., 60° C., 70° C., 80° C. and 90° C.) on the equilibrium pressures achieved and therefore on the amounts of CO₂ captured.

FIG. 5 represents the amount of CO₂ captured per unit of amount of capturing agent available in the comparative absorbent composition 3 considered as reference for the prior art (monoethanolamine) as a function of the equilibrium pressure of the system at the measurement temperatures (in order as above: 40° C., 60° C., 70° C., 80° C. and 90° C.).

FIG. 6 represents the amount of CO₂ captured per unit of amount of capturing agent available in the comparative absorbent composition 4 (KOH alone) (absorption isotherms, in order as above: 40° C., 60° C., 70° C., 80° C. and 90° C.) over the CO₂ equilibrium pressure range of the experiment.

FIG. 7 represents the amount of CO₂ captured per unit of amount of capturing agent available in the absorbent composition 5 according to the invention (2-methylimidazole and KOH) and illustrates the role of the temperature (in order as above: 40° C., 60° C., 70° C., 80° C. and 90° C.) on the equilibrium pressures achieved and therefore on the amounts of CO₂ captured.

FIG. 8 represents the amount of CO₂ captured per unit of amount of capturing agent available in the absorbent composition 6 according to the invention (4(5)-methylimidazole and KOH) as a function of the equilibrium pressure of the system at the measurement temperatures (in order as above: 40° C., 60° C., 70° C., 80° C. and 90° C.).

FIG. 9 represents the amount of CO₂ captured per unit of amount of capturing agent available in the absorbent composition 7 according to the invention (3-aminotriazole and KOH) and illustrates the role of the temperature (in order as above: 40° C., 60° C., 70° C., 80° C. and 90° C.) on the equilibrium pressures achieved and therefore on the amounts of CO₂ captured.

### DESCRIPTION OF THE EMBODIMENTS

The present invention describes a medium for extracting carbon dioxide, more specifically an absorbent composition, used in a process for capturing the carbon dioxide contained in a gaseous effluent, comprising, in an aqueous medium, the combination of a particular base chosen from carbonates and/or hydrogen carbonates and/or hydroxides with a compound chosen from azole-type compounds.

More particularly, the absorbent composition for absorbing CO₂ according to the invention, used in a process for capturing the carbon dioxide contained in a gaseous effluent, comprises the combination of a base B or a mixture of bases B of (hydrogen) carbonate or hydroxide type with at least one compound R(NH)ₙ in an aqueous solvent Z and/or the product obtained by reaction of said base B or said mixture of bases with said compound R(NH)ₙ in said solvent Z.

Furthermore, the invention relates to a carbon dioxide capture process which consists in carrying out the following steps: a) bringing the CO₂-containing gas to be treated into contact with said absorbent composition, so as to obtain a gas depleted in CO₂ and an absorbent composition rich in CO₂, b) regenerating the absorbent composition rich in CO₂, in order to obtain an absorbent composition that can be used again and generate a gas very rich in CO₂. The absorbent composition according to the present invention makes it possible to capture the carbon dioxide contained in a gaseous effluent. Once loaded with carbon dioxide, the absorbent medium can additionally be regenerated under easier conditions than the absorbent solutions from the prior art.

The absorbent composition for absorbing CO₂, according to the present invention, comprises the combination of a base B or a mixture of bases B of (hydrogen) carbonate or hydroxide type corresponding to one of the general formulae M(HCO₃)ₓ or M′_{y}(CO₃) or M″(Oh)w_{w} with a compound R(NH)ₙ in an aqueous solvent Z and/or the product obtained by reaction of said base B or said mixture of bases with said compound R(NH)ₙ in said solvent Z wherein:
B may be a base or a mixture of bases of (hydrogen) carbonate type corresponding to one of the general formulae M(HCO₃)ₓ or M′_{y}(CO₃), M and M′, which are identical or different, being chosen without distinction from:
a monovalent cation such as lithium, sodium, potassium, rubidium or cesium,
a quaternary ammonium cation corresponding to the general formula R₁R₂R₃R₄N⁺, R₁, R₂, R₃ and R₄ being independently chosen from a hydrogen atom, a branched or unbranched, saturated or unsaturated aliphatic, substituted or unsubstituted, saturated or unsaturated alicyclic, substituted or unsubstituted, saturated or unsaturated heterocyclic, or substituted or unsubstituted monoaromatic or polyaromatic hydrocarbon-based group containing between 1 and 20 carbon atoms, it being possible for R₁, R₂, R₃ and R₄ to be bonded in pairs by covalent bonds to form a heterocycle with 5 to 8 atoms,
a divalent cation such as magnesium, calcium or barium,
and wherein x and y are equal to 1 or to 2;
and/or B may be a base B or a mixture of bases B of hydroxide type corresponding to the general formula M″(OH)_{w}, wherein M″ is defined in the same way as M or M′ and w is equal to 1 or 2.
R(NH)ₙ is an unsaturated heterocyclic organic compound or a mixture of unsaturated heterocyclic organic compounds, wherein the radical R is an alicyclic group, monoaromatic or polyaromatic group, or nitrogen-containing (i.e. comprising at least one nitrogen atom) heterocyclic group, n being between 1 and 20.
The aqueous solvent Z is essentially water or a mixture of solvents comprising predominantly water.

The group R is bonded to n —NH units in accordance with the rules of organic chemistry. Preferably, the number of —NH units (n) is between 1 and 6 and very preferably n is equal to 2 or 3.

The group R may contain one or more heteroatoms present by means of functions such as alcohols, ethers, thioethers, nitriles, ketones, sulfones, sulfoxides, amides or amines.

When (NH) is present in a ring, the latter may comprise alkyls and/or additional functional groups.

In one embodiment, R(NH)ₙ is a heterocyclic organic compound or a mixture of heterocyclic organic compounds comprising at least 2, 3 or 4 nitrogen atoms in a ring of five or more atoms respectively comprising at least 3, 2 or 1 carbon atom(s).

Preferably, the compound R(NH)ₙ is an organic compound with an unsaturated heterocycle containing five atoms, having at least one nitrogen atom per four carbon atoms.

R very preferably represents a ring comprising 3, 2 or 1 carbon atom(s).

Advantageously, said ring comprises at least 2 night stay atoms, or even at least 3 or at least 4 nitrogen atoms.

Advantageously, the absorbent composition according to present invention comprises components that are readily available and easy to use.

The fact of obtaining an absorbent composition that is effective in an aqueous medium has several advantages. Specifically, water is a non-toxic, inexpensive and readily available solvent.

Furthermore, with water, it is possible to dispense with the gas purification operations that are very often necessary, for example when the solvent is an organic compound such as for example methanol. Specifically, small amounts of solvent are inevitably entrained in the gases after separation of the carbon dioxide and require expensive additional purification steps. Water also has the advantage of not degrading, unlike the organic molecules generally used as solvents.

Water furthermore has the advantage of being able to be vaporised in situ in the step of regenerating the absorbent composition enriched in CO₂. The steam thus generated makes it possible to heat the absorbent composition and/or to carry out the stripping (steam entrainment) of the CO₂.

The base B or the mixture of bases B of (hydrogen) carbonate or hydroxide type corresponds to one of the general formulae M(HCO₃)ₓ or M′_{y}(CO₃) or M″(OH)_{w}, wherein M, M′, M″, which are identical or different, are chosen without distinction from:
a monovalent cation such as lithium, sodium, potassium, rubidium or cesium,
a quaternary ammonium cation corresponding to the general formula R₁R₂R₃R₄N⁺, R₁, R₂, R₃ and R₄ being independently chosen from a hydrogen atom, a branched or unbranched, saturated or unsaturated aliphatic, substituted or unsubstituted, saturated or unsaturated alicyclic, substituted or unsubstituted, saturated or unsaturated heterocyclic, or substituted or unsubstituted monoaromatic or polyaromatic hydrocarbon-based group containing between 1 and 20 carbon atoms, it being possible for R₁, R₂, R₃ and R₄ to be bonded in pairs by covalent bonds to form a heterocycle with 5 to 8 atoms,
a divalent cation such as magnesium, calcium or barium,

and wherein x, y, w are independently equal to 1 or to 2.

Among the bases or mixtures of bases B of carbonate or hydrogen carbonate type used in the absorbent composition according to the present invention, mention may for example be made, without being exhaustive, of: the carbonates of lithium, sodium, potassium, cesium and rubidium, magnesium, calcium, barium, tetramethylammonium, tetraethylammonium, benzyltrimethylammonium and decyltrimethylammonium and the bicarbonates (or hydrogen carbonates) of lithium, sodium, potassium, cesium and rubidium, magnesium, calcium, barium, tetramethylammonium, tetraethylammonium, benzyltrimethylammonium and decyltrimethylammonium, alone or as a mixture.

In this case, very preferably, the base B is chosen from potassium or sodium carbonate.

Among the bases or mixtures of bases B of hydroxide type used in the absorbent composition according to the present invention, mention may for example be made, without being exhaustive, of: the hydroxides of lithium, sodium, potassium, cesium and rubidium, magnesium, calcium and barium, alone or as a mixture. Preferably, the base B is sodium or potassium hydroxide, very preferably, the base B is potassium hydroxide.

The compound of formula R(NH)ₙ may be chosen for example, without being exhaustive, from azoles such as imidazole,1,2,4-triazole, 2-methylimidazole, 1,2,3-triazole, 4(5)-methylimidazole, 3-amino-1,2,4-triazole, 2-isopropylimidazole, 2-ethyl-4-methylimidazole, 2-imidazolidone, 3,5-diamino-1,2,4-triazole, L-histidine, adenine, barbituric acid, methyl-1H-1,2,4-triazole-3-carboxylate, 2-ethylimidazole, 4-methyl-5-imidazolecarboxaldehyde and 2,4-dimethylimidazole.

Preferably, the compound R(NH)ₙ may be chosen from imidazole,1,2,4-triazole, 2-methylimidazole, 1,2,3-triazole, 4(5)-methylimidazole and 3-amino-1,2,4-triazole.

Very preferably, the compound R(NH)ₙ is imidazole or 1,2,4 triazole or 2-methylimidazole or 4(5)-methylimidazole or 3-amino-1,2,4-triazole, since these compounds allow a good compromise between the loading ratio and the enthalpy of absorption.

Even more preferably, the compound R(NH)ₙ may be chosen from imidazole, 2-methylimidazole, 4(5)-methylimidazole.

The solvent Z may be essentially water. The term “essentially” is understood for the purposes of the present invention to mean that in this case the solvent consists solely of water, without however excluding from the invention the possibility of also having certain inherent impurities which could be included in the water.

The solvent Z may alternatively be a mixture of solvents comprising water.

Preferably, in the case where the solvent Z consists of a mixture of solvents, water remains the main constituent. Preferentially, depending on the number of constituents of the solvent Z, the water may thus be present at a content of at least 30% by weight relative to the total amount of solvent. Very preferably, the mixture of solvents may comprise at least 50% by weight of water, and even very preferentially at least 60% by weight of water.

In this case, the solvent is water combined with another solvent or with a mixture of solvents that is/are miscible with water. These solvents are chosen from glycols, polyethylene glycols, polypropylene glycols, ethylene glycol-propylene glycol copolymers, glycol ethers, thioglycols, thioalcohols, sulfones, sulfoxides, alcohols, ureas, lactams, N-alkyl pyrrolidones, N-alkyl piperidones, cyclotetramethylene sulfones, N-alkylformamides, N-alkylacetamides, ether-ketones, alkyl phosphates, alkylene carbonates, dialkyl carbonates and derivatives thereof.

By way of example and nonlimitingly, mention may be made, without being exhaustive, of tetraethylene glycol dimethyl ether, sulfolane, dimethyl sulfoxide, ethanol, polyethylene glycols-200/400/600, N-methylpyrrolidone, 1,3-dioxan-2-one, dimethylformamide, dimethylacetamide, formamide, acetamide, 2-methoxy-2-methyl-3-butanone, 2-methoxy-2-methyl-4-pentanone, tetrahydropyrimidone, dimethyl thiodipropionate, bis(2-hydroxyethyl)sulfone or tributyl phosphate.

Generally, the absorbent composition may contain from 1% to 90% by weight of water, preferably from 20% to 80% by weight of water, more preferably at least 50% water.

It has been discovered that the judicious combination, owing to their nature and owing to their proportion, of the two species in the form [B+αR(NH)ₙ] in an aqueous medium denoted [B+αR(NH)ₙ]_{aq} constitutes an advantageous absorbent composition for carbon dioxide. Combined with each mole of B are α moles of R(NH)ₙ and the species thus formed has the property of reacting with CO₂ in an aqueous medium according to the general scheme:

[B+αR(NH)ₙ]_{aq}+γCO₂⇒[B,αR(NH)n,γ(CO₂)]_{aq} Chem 1

wherein γ represents the number of moles of CO₂ chemically combined with the reactive species contained in the absorbent composition [B+αR(NH)ₙ]_{aq}.

The value of the coefficient α depends on the nature of the two chemical species involved. α is a positive number. Preferably, α must satisfy the condition that at least one hydrogen atom bonded to N in the formula R(NH)ₙ must be combined with a basic function provided by B. For example, in the case of a monobase B=M″OH combined with a compound RNH, α is preferably greater than or equal to 1.

In this way, the CO₂-containing gas to be treated, after contact with the absorbent composition, will be depleted in CO₂.

The carbon dioxide may be in excess or in deficit relative to [B+αR(NH)ₙ]_{aq}, which means that after capturing CO₂ the absorbent composition may contain, in addition to the CO₂ capture product [B, αR(NH)ₙ, γ(CO₂)]_{aq}, an excess amount of CO₂ or an excess amount of [B+αR(NH)ₙ]_{aq}.

This reaction is reversible. The back reaction can be represented by the general scheme:

[B,αR(NH)ₙ,γ(CO₂)]_{aq}⇒[B+αR(NH)ₙ]_{aq}+γCO₂ Chem 2

Thus, an operation is carried out on the absorbent composition which aims to restore [B+αR(NH)ₙ]_{aq} and CO₂. This operation makes it possible to generate a gas very rich in CO₂ and to regenerate the absorbent composition.

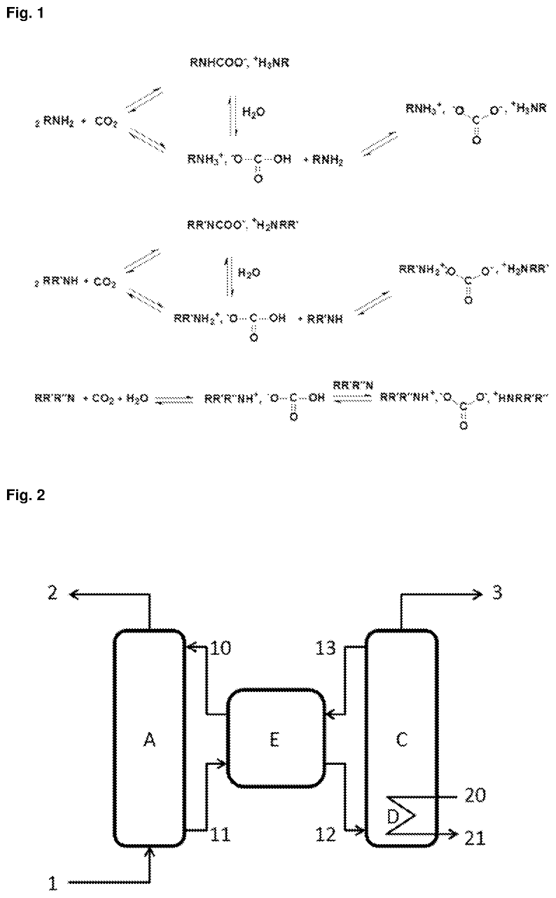

The operation for regenerating the absorbent composition may be carried out under conditions which require little energy and notably less energy than the operation which would be necessary to regenerate the same amount of CO₂ when the latter is extracted using one or more primary, secondary or tertiary amines or a composition thereof resulting in carbamates, in hydrogen carbonates or in carbonates according to the balanced reactions presented previously as known to a person skilled in the art (FIG. 1) and conventionally used for capturing CO₂.

Similarly, this operation through regenerating the absorbent composition may be carried out under conditions which require little energy and notably less energy than the operation which would be necessary to regenerate the same amount of CO₂ when the latter is extracted using a base B used alone in the absence of R(NH)ₙ in an aqueous medium.

It was observed that using only R(NH)ₙ in an aqueous medium did not make it possible to capture as much CO₂ present in a gas as the mixture [B+αR(NH)ₙ]_{aq}. However, the combination of the base or of the mixture of bases B and the compound R(NH)ₙ in an aqueous medium according to a judicious choice and in proportions that are preferably optimized makes it possible to carry out the steps of extracting CO₂ and of regenerating the absorbent composition according to the invention.

The system for capturing CO₂ according to the invention may be used in a process for treating gas containing CO₂.

The process of capturing carbon dioxide schematically comprises the following steps: a) the CO₂-containing gas to be treated is brought into contact with an absorbent composition, so as to obtain a gas depleted in CO₂ and an absorbent composition rich in CO₂, b) the absorbent composition rich in CO₂ is regenerated, so as to obtain a regenerated absorbent composition that can be used again, and generate a gas very rich in CO₂.

More specifically, as depicted in FIG. 2, in a process for capturing carbon dioxide, the gas to be treated (1) is introduced into a gas-liquid contactor (A) where it is brought into contact with a regenerated liquid absorbent composition (10). This results in a treated gas depleted in CO₂ (2) and a separating medium rich in CO₂ (11). The absorbent composition rich in CO₂ is introduced into a heat exchange device (E) so as to produce a heated absorbent composition rich in CO₂ (12). The heat is provided by the cooling of the hot absorbent composition lean in CO₂ (13). This also results in a stream of cooled absorbent composition lean in CO₂ (10). External hot and cold sources, not represented, may be used to adapt the temperature of the streams (10) and (12) to the operating conditions of the components (A) and (C) respectively. The heated absorbent composition rich in CO₂ (12) is introduced into gas-liquid separation equipment (C) where the separating medium is regenerated. The driving force of this separation is the heat supplied by a hot source (20) by means of a heat exchange device (D). This results in a cooled hot source (21). Alternatively, this hot source can be supplemented, completely or partly, by a stripping gas, not represented. The regeneration of the separating medium produces a hot separating medium lean in CO₂ (13) and a gas stream rich in CO₂ (3). Depending on the regeneration method chosen, the CO₂ of stream (3) may be mixed with a stripping gas. Alternatively, the stream (3) may be connected to a device intended to give rise to the expansion of the separating medium rich in CO₂ and thus constitute, completely or partly, the driving force of the regeneration. The hot separating stream lean in CO₂ (13) transfers its heat into the device (E) described above in order to provide the device (A) with a cooled separating medium lean in CO₂ (10) at the temperature suitable for the operating conditions of (A).

The temperature during step (A) may advantageously be between 20° C. and 80° C. and preferably between 30° C. and 70° C.

According to the invention, the regeneration of the absorbent composition according to the reaction:

[B,αR(NH)ₙ,γ(CO₂)]_{aq}⇒[B+αR(NH)ₙ]_{aq}+γCO₂ Chem 2

may be carried out:
either by steam entrainment (or stripping) by means of a gas that entrains, in the vapor phase, the carbon dioxide contained in the solvent to be regenerated. The stripping gas may for example be formed in situ by vaporization of one or more compounds present in the absorbent composition: it may be one of the compounds defined according to the invention, but it may also be a compound derived from the gas to be treated which might have been absorbed with the CO₂, such as water for example in the case of a flue gas. The stripping gas may also be added to the regeneration step: it may for example be nitrogen, steam or a portion of the treated gas resulting from the absorption step.
or by heating;
or by expansion;
or by various combinations of the three cited regeneration methods.

### Examples

The examples presented below illustrate the technical advantage of the present invention without limiting the scope thereof. They present in particular the CO₂ absorption capacity of various absorption media and the absorption energies of the species of interest of the various absorbent compositions under the conditions for implementation of the examples.

The tests of absorption of the CO₂ in the various absorbent compositions are carried out according to the following procedure:

The absorbent composition is formed of a mixture of compounds. The mixture is firstly degassed under vacuum, with controlled stirring and controlled temperature in order to desorb the residual gases, including CO₂. A known mass of mixture is then injected under an inert atmosphere into a closed reactor, in order to avoid any contamination by ambient CO₂. The vacuum is then produced in the reactor until the saturation vapour pressure of the mixture at the temperature of interest is reached.

Next, at 40° C., 60° C., 70° C., 80° C. and 90° C. volumes of pure CO₂ are injected into the reactor by calibrated ballast discharge in order to achieve the various pressure setpoints between 0 and 3 bar defined by an automaton. At each pressure setpoint reached in the reactor following the injection of CO₂, a hold of 40 min is performed in order to obtain liquid-vapor equilibrium. Thus, by monitoring the pressure within the reactor as a function of time, for each temperature a series of points is obtained, corresponding to the amount of CO₂ injected into the reactor. Knowing the volumes of the vacuum reactor and the volume of the mixture inserted, the volume of the gas phase can be calculated, and therefore the number of moles of CO₂ in the gas phase and the number captured can be deduced therefrom. When the CO₂ absorption step is finished, the loading ratio is determined. The loading ratio is defined by a person skilled in the art as being the number of moles of CO₂ captured divided by the number of moles of the basic compound (base or mixture of bases) B present in the absorbent composition.

Via the series of isotherms between 40° C. and 90° C., it is possible to determine the enthalpy of reaction of the CO₂ in the mixture as a function of the loading ratio alpha by applying the Gibbs-Helmholtz equation known to a person skilled in the art as the relationship between the temperature of the mixture, the partial pressure of CO₂ and the enthalpy of reaction.

In addition, the loading ratios measured at the partial pressures typical of the proportions found at the outlets of emitting plants (for example: coal-fired power plants with P_{CO2}=10 kPa) may be reported in order to observe the loading ratios that can be achieved by the mixtures.

The following mixtures were evaluated:

Absorbent composition 1 (according to the invention) is obtained by mixing 0.14 mol of KOH with 0.14 mol of imidazole and 70 g of water.

Absorbent composition 2 (according to the invention) is obtained by mixing 0.14 mol of KOH with 0.14 mol of 1,2,4-triazole and 70 g of water.

Absorbent composition 3 (comparative) is obtained by mixing 30 g (0.49 mol) of monoethanolamine (MEA) with 40 g of water. This absorbent composition corresponds to a 30 wt % aqueous solution of ethanolamine (MEA) which is a reference solvent well known to person skilled in the art for capturing CO₂ in flue gases.

Absorbent composition 4 (comparative) is obtained by mixing 0.14 mol of KOH and 70 g of water. This absorbent composition contains a hydroxide base, but does not contain the compound R(NH)ₙ.

Absorbent composition 5 (according to the invention) is obtained by mixing 0.14 mol of KOH with 0.14 mol of 2-methylimidazole and 70 g of water.

Absorbent composition 6 (according to the invention) is obtained by mixing 0.14 mol of KOH with 0.14 mol of 4(5)-methylimidazole and 70 g of water.

Absorbent composition 7 (according to the invention) is obtained by mixing 0.14 mol of KOH with 0.14 mol of 3-amino-1,2,4-triazole and 70 g of water.

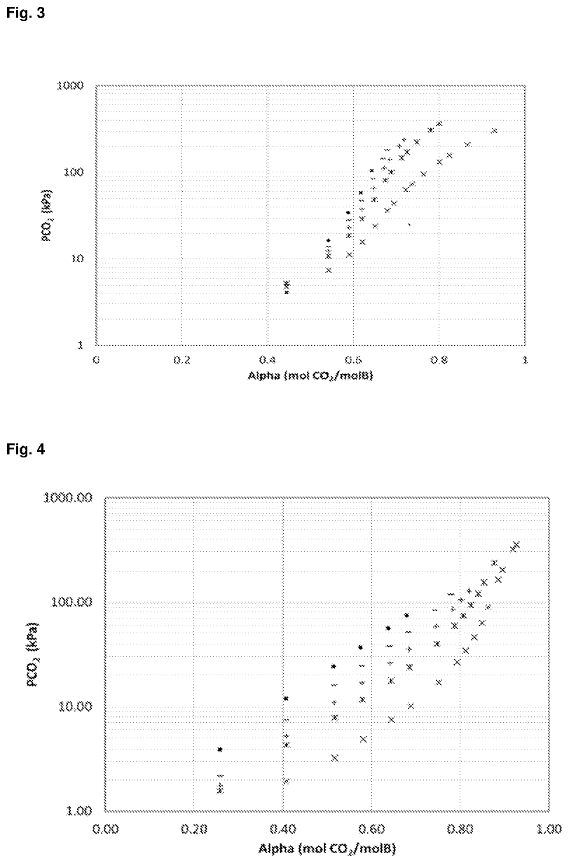

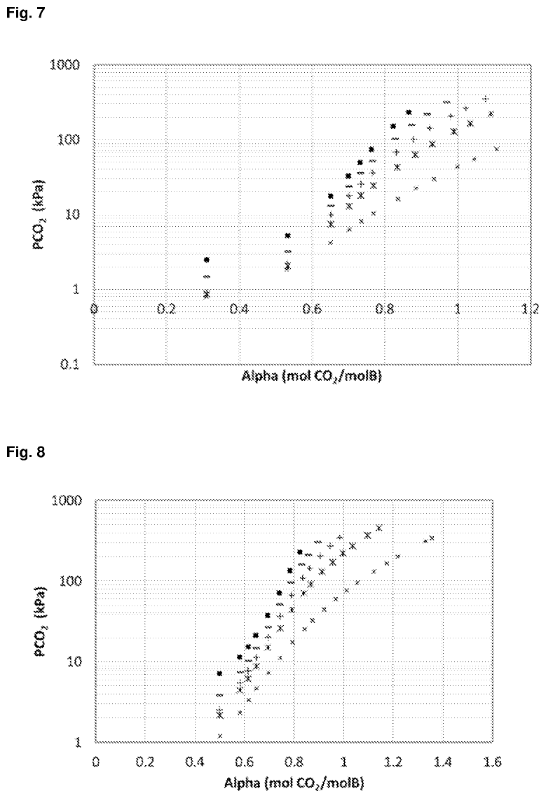

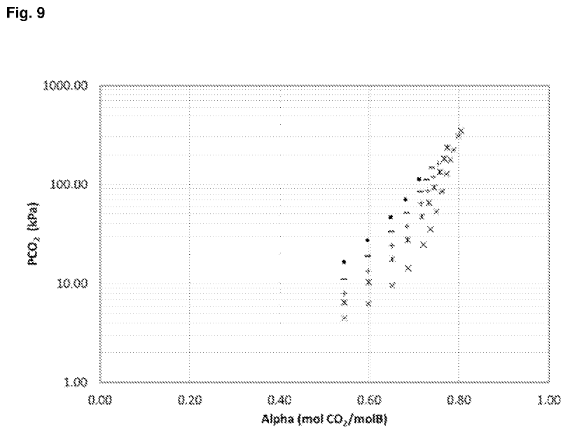

FIGS. 3, 4, 5, 6, 7, 8 and 9 present the absorption isotherms at 40, 60, 70, 80 and 90° C. of CO₂ of mixtures 1, 2, 3, 4, 5, 6 and 7.

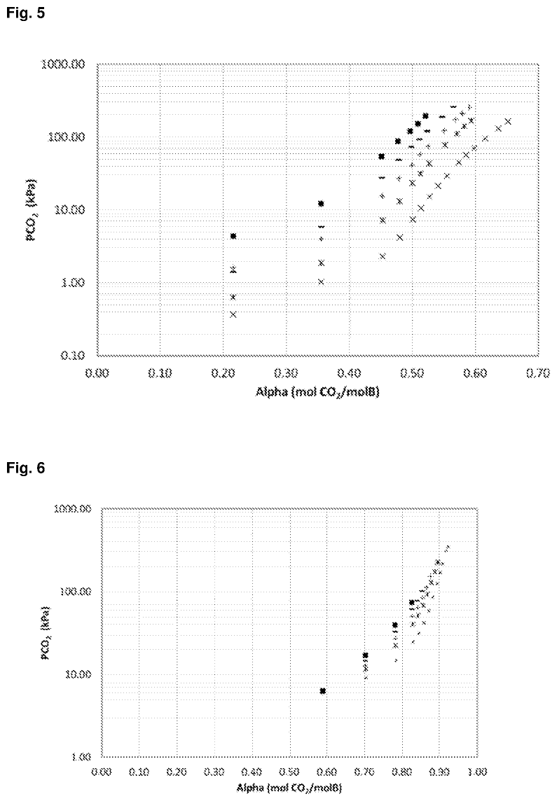

As seen in FIGS. 3, 4 and 8 in comparison with FIG. 5, the capacities achieved at equilibrium at low partial pressures such as 5 kPa (40° C.) of CO₂ greater or at least equal to those of the compound from the prior art in the absorbent composition of the extraction medium 3. where [alpha: medium 1: 5 kPa]=0.48 mol CO₂/mol B, [alpha: medium 2: 5 kPa]=0.58 mol CO₂/mol B and alpha: medium 7: 5 kPa]=0.56 mol CO₂/mol B versus [alpha: medium 3: 5 kPa]=0.48 mol CO₂/mol B. For 10 kPa of CO₂ and at thermodynamic equilibria, the capacities achieved are all greater than that achieved by the mixture 3 representing the prior art (see table 1).

Particular attention may be made to the even greater performance obtained with the absorbent compositions of extraction media 5 and 6, where for a partial pressure of CO₂ at equilibrium for low pressures of 5 kPa (40° C.), the capacities achieved are even greater: [alpha: medium 5: 5 kPa]=0.67 mol CO₂/mol B, [alpha: medium 6: 5 kPa]=0.65 mol CO₂/mol B and [alpha: medium 7: 5 kPa]=0.56 mol CO₂/mol B versus [alpha: medium 3: 5 kPa]=0.48 mol CO₂/mol B.

Table 1 below presents, for the various absorbent compositions, the absorption enthalpies according to a same loading ratio for comparison and the loading ratio of CO₂ after absorption under 10 kPa at 40° C.

TABLE 1

| | Loading ratio | Enthalpy of absorption |
|---|---|---|
| | (mol CO₂/mol B) | (KJ/mol) |
| | CO₂ absorbent composition | |
| | P_{CO2} = 10 kPa | alpha = 0.5 |
| 1 (according to the invention) | 0.59 | 16 |
| 2 (according to the invention) | 0.69 | 39 |
| 3 (comparative) | 0.51 | 70 |
| 4 (comparative) | 0.70 | 100 |
| 5 (according to the invention) | 0.70 | 34 |
| 6 (according to the invention) | 0.74 | 34 |
| 7 (according to the invention) | 0.65 | 27 |

These examples show that absorbent compositions 1 and 2 and also 5, 6 and 7 according to the invention capture more CO₂ and are regenerated more easily than absorbent composition 3 according to the prior art, due to a lower enthalpy of absorption of the CO₂.

The regeneration is especially facilitated relative to mixture 4 which does not comprise the compound R(NH)ₙ.

Furthermore, the comparison of the results of absorbent composition 4 with absorbent compositions 1, 2, 5, 6 and 7 according to the invention clearly shows that it is the combination of the compound R(NH)ₙ with the compound B in an aqueous medium according to the invention which enables an easier regeneration of the absorbent composition for equivalent amounts of absorbed CO₂, and not the compound B used alone in solution in water.

1. An absorbent composition for absorbing the carbon dioxide contained in a gaseous effluent comprising the combination of a base B or a mixture of bases B with at least one compound R(NH)ₙ in an aqueous solvent Z and/or the product obtained by reaction of said base B or of said mixture of bases B with said compound R(NH)ₙ in said aqueous solvent Z, wherein:
B is a base or a mixture of bases corresponding to one of the general formulae M(HCO₃)ₓ or M′_{y}(CO₃) or M″(OH)_{w}, where M, M′, M″, which are identical or different, are chosen without distinction from:
a monovalent cation such as lithium, sodium, potassium, rubidium or cesium,
a quaternary ammonium cation corresponding to the general formula R₁R₂R₃R₄N⁺ wherein R₁, R₂, R₃ and R₄ are independently chosen from a hydrogen atom, a branched or unbranched, saturated or unsaturated aliphatic, substituted or unsubstituted, saturated or unsaturated alicyclic, substituted or unsubstituted, saturated or unsaturated heterocyclic, substituted or unsubstituted monoaromatic or polyaromatic hydrocarbon-based group containing between 1 and 20 carbon atoms, it being possible for R₁, R₂, R₃ and R₄ to be bonded in pairs by covalent bonds to form a heterocycle with 5 to 8 atoms,
a divalent cation such as magnesium, calcium or barium,
and wherein x, y, w are equal to 1 or to 2;
R(NH)ₙ is an unsaturated heterocyclic organic compound or a mixture of unsaturated heterocyclic organic compounds, wherein the radical R is an alicyclic, monoaromatic or polyaromatic, or heterocyclic group having at least one nitrogen atom, and n is between 1 and 20, preferably between 1 and 6, very preferably n is equal to 2 or 3;
Z is essentially water or a mixture of solvents comprising water.

2. The absorbent composition for absorbing carbon dioxide as claimed in claim 1, wherein the base B or the mixture of bases B is chosen from the carbonates of lithium, sodium, potassium, cesium, rubidium, magnesium, calcium, barium, tetramethylammonium, tetraethylammonium, benzyltrimethylammonium and decyltrimethylammonium, the bicarbonates (or hydrogen carbonates) of lithium, sodium, potassium, cesium, rubidium, magnesium, calcium, barium, tetramethylammonium, tetraethylammonium, benzyltrimethylammonium and decyltrimethylammonium, the hydroxides of lithium, sodium, potassium, cesium and rubidium, magnesium, calcium and barium, alone or as a mixture.

3. The absorbent composition for absorbing carbon dioxide as claimed in claim 1, wherein the compound R(NH)n is an unsaturated heterocyclic organic compound comprising at least 2, 3 or 4 nitrogen atoms in a ring of 5 or more atoms respectively comprising at least 3, 2 or 1 carbon atom(s), preferably an organic compound with an unsaturated heterocycle containing five atoms, having at least one nitrogen atom per four carbon atoms.

4. The absorbent composition for absorbing carbon dioxide as claimed in claim 1, wherein said radical R contains one or more heteroatoms, present by means of functions such as alcohols, ethers, thioethers, nitriles, ketones, sulfones, sulfoxides, amides or amines.

5. The absorbent composition for absorbing carbon dioxide as claimed in claim 1, wherein the compound R(NH)ₙ is chosen from azoles such as imidazole, 1,2,4-triazole, 2-methylimidazole, 1,2,3-triazole, 4(5)-methylimidazole,
3-amino-1,2,4-triazole, 2-isopropylimidazole, 2-ethyl-4-methylimidazole,
2-imidazolidone, 3,5-diamino-1,2,4-triazole, L-histidine, adenine, barbituric acid, methyl-1H-1,2,4-triazole-3-carboxylate, 2-ethylimidazole, 4-methyl-5-imidazolecarboxaldehyde, 2,4-dimethylimidazole, very preferably chosen from imidazole, 1,2,4-triazole, 2-methylimidazole, 1,2,3-triazole, 4(5)-methylimidazole and 3-amino-1,2,4-triazole.

6. The absorbent composition for absorbing carbon dioxide as claimed in claim 5, wherein the compound R(NH)ₙ is chosen from imidazole, 2-methylimidazole, 4(5)-methylimidazole, 1,2,4-triazole, 3-amino-1,2,4 triazole.

7. The absorbent composition for absorbing carbon dioxide as claimed in claim 1, wherein the solvent Z is essentially water.

8. The absorbent composition for absorbing carbon dioxide as claimed in claim 1, wherein the solvent Z is water combined with another solvent or with a mixture of solvents that is/are miscible with water.

9. The absorbent composition for absorbing carbon dioxide as claimed in claim 8, wherein the water represents at least 30% by weight, preferably 50% by weight, very preferably 60% by weight relative to the total amount of solvent Z.

10. The absorbent composition for absorbing carbon dioxide as claimed in claim 8, wherein said other solvent is chosen from glycols, polyethylene glycols, polypropylene glycols, ethylene glycol-propylene glycol copolymers, glycol ethers, thioglycols, thioalcohols, sulfones, sulfoxides, alcohols, ureas, lactams, N-alkyl pyrrolidones, N-alkyl piperidones, cyclotetramethylene sulfones, N-alkylformamides, N-alkylacetamides, ether-ketones, alkyl phosphates, alkylene carbonates, dialkyl carbonates and derivatives thereof.

11. The absorbent composition for absorbing carbon dioxide as claimed in claim 10, wherein said other solvent is chosen from tetraethylene glycol dimethyl ether, sulfolane, dimethyl sulfoxide, ethanol, polyethylene glycols-200/400/600, N-methylpyrrolidone, 1,3-dioxan-2-one, dimethylformamide, dimethylacetamide, formamide, acetamide, 2-methoxy-2-methyl-3-butanone, 2-methoxy-2-methyl-4-pentanone, tetrahydropyrimidone, dimethyl thiodipropionate, bis(2-hydroxyethyl)sulfone or tributyl phosphate.

12. The absorbent composition for absorbing carbon dioxide as claimed in claim 1, wherein α moles of R(NH)ₙ are combined with each mole of B, α being a positive number defined in order to satisfy the condition that at least one hydrogen atom bonded to N in the formula R(NH)ₙ must be combined with a basic function provided by B.

13. A process for capturing carbon dioxide comprising a step of bringing the CO₂-containing gaseous effluent to be treated into contact with the absorbent composition as claimed in claim 1 so as to deplete said gaseous effluent of CO₂ and to enrich said absorbent composition in CO₂ and a step of regenerating said absorbent composition and of generating a gas very rich in CO₂.

14. The process as claimed in claim 13, characterized in that the regeneration of the absorbent composition enriched in CO₂ is carried out by steam entrainment by means of a gas that entrains the carbon dioxide in the vapor phase or by heating or by expansion or by a combination of steps chosen from steam entrainment by means of a gas that entrains the carbon dioxide in the vapor phase, expansion and/or heating.
